(19) United States
(12) Patent Application Publication
(10) Pub. No.: US 2026/0218740 A1
(43) Pub. Date: Jul. 30, 2026

(54) Rod Connector Systems and Methods of Use

(71) Applicant: House of Atlas, LLC, Evanston, IL (US)

(72) Inventors: Jason Moss, Libertyville, IL (US); Alan Arthur Ford, Sturgis, MI (US); Matthew Berman, Chicago, IL (US)

(21) Appl. No.: 19/040,666

(22) Filed: Jan. 29, 2025

(51) Int. Cl. F16B 7/18; A47H 1/02

(52) U.S. Cl. CPC F16B 7/182; A47H 1/02; A47H 2001/0215

(57) ABSTRACT

A rod connector includes an insertable body having a first face at a first end and a second face at a second end, a first threaded shaft extending from the first planar face, and a second threaded shaft extending from the second planar face. The first and second threaded shafts are threadable into threaded holes of first and second attachment plates within interiors of the first and second rods. The first attachment plate is spaced a first distance from an end of the first rod and the second attachment plate is spaced a second distance from an end of the second rod. When the first and second threaded shafts are threaded in the first and second threaded holes until the attachment plates and the planar faces engage, the respective ends of the first and second rods are brought into engagement, defining a connected state and a smooth transition between the first rod and the second rod.

### FIELD

This disclosure relates to connectors and, in particular, to connectors for joining rods together.

### BACKGROUND

Many homeowners place curtain rods above windows to enable curtains to be drawn open or closed over the window to selectively control the amount of light entering a room from outside the home. Curtains may also be drawn closed to inhibit those outside of the home from viewing inside the home through the window. Curtain rods are also often used with showers to hang a shower curtain along an opening to a shower to prevent water from exiting the shower.

Since the curtain rods must span the width of a window or the length of a shower, the curtain rods can be very long. Even where telescoping rods are used, the length of each rod may be very long. As a result, the curtain rods are placed in long boxes for sale, storage, and transportation. Long boxes are more costly to produce, to transport, and to store in a warehouse and consume too much display space in retail stores.

Further, connections can also provide a rough transition between rods. In many instances, curtains are suspended from the rods using loops and hooks. The loops and hooks have to slide along the rods to open and close the curtain. When there is a rough transition between the rods, the loops and hooks tend to hang up on the transitions as they slide along the rods.

### BRIEF DESCRIPTION OF THE DRAWINGS

FIG. 1 is a perspective view of a rod connector according to a first embodiment.

FIG. 2 is a plan view of the rod connector of FIG. 1.

FIG. 3 is a partially cutaway view of a rod assembly showing the rod connector of FIG. 1 connecting two rods.

FIG. 4 is a partial cutaway view of a first rod and first attachment plate of the rod assembly of FIG. 3.

FIG. 5 is a partially cutaway view of a rod assembly showing a rod connector according to a second embodiment.

### DETAILED DESCRIPTION

A rod connector is provided for coaxially connecting two rods together. The rods may be, for example, curtain rods for supporting curtains over a window or shower rods for supporting a shower curtain. The rod connector also may be used, for example, to connect rods used to support a shower caddy, rods of a storage support, and rods of a closet pole (e.g., for hanging clothes). Those having skill in the art will readily appreciate other applications where the rod connector may be used to join two rods together to increase the overall combined rod length. Use of the rod connector enables two rods to be joined together to form a combined rod having an increased length and smooth transition from one rod to the other. The two rods may be separate when packaged enabling a box having a shorter length to be used which reduces the costs of the box and costs associated with shipping, displaying, and storing the packaged rod system. The end user or installer may join the two rods together using the rod connector to provide a combined rod having a desired length, e.g., a length that spans the width of a window or the length of a shower.

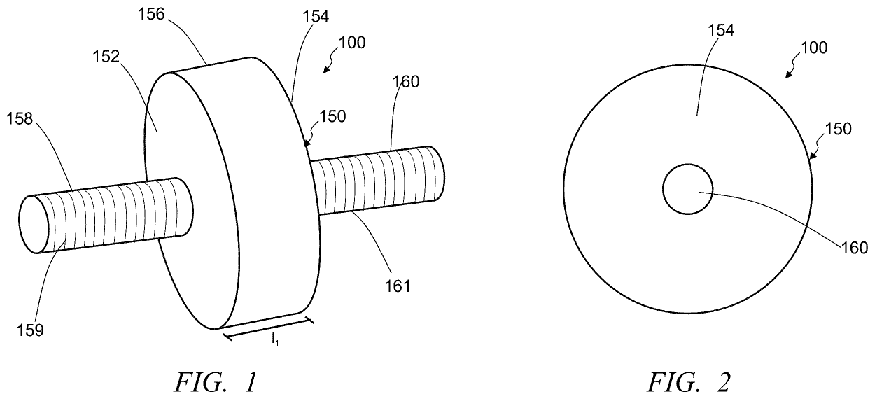

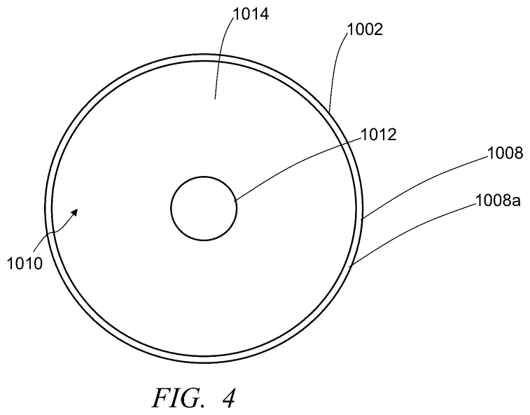

With respect to FIGS. 1-4, a rod connector 100 and rod assembly 1000 are shown. The rod connector 100 connects a first rod 1002 to a second rod 1004 such that there is a smooth transition from the first rod 1002 to the second rod 1004.

The rod connector 100 includes a main cylindrical body 150 or disc body, the main cylindrical body 150 defined by a first end with a first planar face 152, a second end opposite the first end with a second planar face 154, and a radial cylindrical side surface 156. In some approaches, the radial cylindrical side surface 156 is entirely smooth. The first planar face 152 and the second planar face 154 may also be entirely smooth, except for the shafts 158, 160 extending axially therefrom.

In embodiments, the cylindrical body has a uniform diameter. The diameter of the cylindrical body 150 may be smaller than the inner diameter of the first rod 1002 and the second rod 1004 so that the cylindrical body 150 can be inserted within the first rod 1002 and the second rod 1004. In some approaches the cylindrical body 150 may be sized so that it is spaced from and does not engage the interior side surfaces 1016, 1036 of the rods 1002, 1004. In some approaches, the cylindrical body 150 has a diameter that is about 30% to about 95%, about 50% to about 95%, or between about 65% to about 90% of the inner diameter of the first rod 1002 and the second rod 1004. In other approaches the diameter is only slightly smaller than the inner diameter of the first rod 1002 and the second rod 1004 such that the cylindrical body 150 engages interior side surfaces 1016, 1036 of the rods 1002, 1004.

The rod connector 100 further includes the first shaft 158 extending axially from a center of the first planar face 152 and the second shaft 160 extending axially from a center of the second planar face 154. The first shaft 158 and the second shaft 160 may be configured to couple to the first rod 1002 and the second rod 1004, respectively. More specifically, in some approaches the first rod 1002 and the second rod 1004 include respective first and second attachment plates, bodies, or nuts 1010, 1030 within respective interiors 1006, 1026 of the rods 1002, 1004 that receive and connect to the first and second shafts 158, 160, as described further below.

The shafts 158, 160 have a diameter that is smaller than the diameter of the cylindrical body 150, for instance, at most about 80% of the diameter of the cylindrical body 150 (the diameter measurement including the threading). In some approaches, the diameter of the shafts 158, 160 is at most about 70%, at most about 60%, or at most about 50% of the diameter of the cylindrical body so that there is significant surface area contact between the cylindrical body and the attachment plates 1010, 1030 described below. In some approaches, the diameter of the shafts 158, 160 is at least about 15% the diameter of the cylindrical body 150. In various approaches, the diameter of each shaft 158, 160 may be from about 15% to about 70%, from about 15% to about 60%, from about 15% to about 50%, from about 15% to about 40%, or from about 20% to about 35% of the diameter of the cylindrical body 150.

In some approaches, the shafts 158, 160 are longer than a thickness of the attachment plates 1010, 1030 so that the shafts 158, 160 can extend through and past the attachment plates 1010, 1030 when the rod connector 100 is fully installed. Each shaft 158, 160, in some embodiments, may be at least as long as a length l₁ (FIG. 1) of the cylindrical body 150 or longer than the length l₁ of the cylindrical body 150. In some embodiments, a ratio of the length of the cylindrical body 150 to a length of each shaft may be at least 1:6, at least 1:5, at least 1:4, at least 1:3, at least 1:2, or at least 1.3:2. In some approaches, the ratio of the length of the cylindrical body 150 to a length of each shaft is at most 1.5:1, at most 1:1, at most 0.9:1, or at most 0.8:1. In some approaches, the first shaft 158 and the second shaft 160 are portions of a single shaft that extends through a central hole of the cylindrical body 150.

In some approaches, the first shaft 158 and the second shaft 160 include respective threading 159, 161. The threading 159, 161 may be external threading (continuous or discontinuous) for respective mating with internal threading within the first rod 1002 and the second rod 1004 (e.g., internal threading of the attachment plates 1010, 1030). In some embodiments, the threading 159, 161 extends an entire length or substantially an entire length of each shaft 158, 160. In some embodiments, the threading 159, 161 extends all the way to the cylindrical body 150. In other embodiments, the threading may extend only along a select portion of each shaft 158, 160.

As noted above, the first attachment plate 1010 is positioned within an interior 1006 of the first rod 1002 and the second attachment plate 1030 is positioned within an interior 1026 of the second rod 1004. The first attachment plate 1010 may define a wall having a generally cylindrical or disc shape extending perpendicularly to the interior side surface 1016 of the first rod. The first attachment plate 1010 has a diameter that is about the same or slightly less than an inner diameter of the first rod 1002 so that an entire periphery of the first attachment plate 1010 is substantially flush with or engaging the interior side surface 1016 of the first rod 1002. The first attachment plate 1010 may be an insert that is fixed against movement relative to the first rod 1002 (e.g., by gluing, welding, friction fit, indenting, etc.) or may be formed integrally within the first rod 1002. In one approach, the attachment plates 1010, 1030 are nuts that are welded or soldered to the rods 1002, 1004.

The first attachment plate 1010 includes a first planar surface 1014, a second planar surface 1015 opposite the first planar surface 1014, and a hole 1012 extending centrally through a thickness of the first attachment plate 1010 between the first planar surface 1014 and the second planar surface 1015. The hole 1012 is sized to receive the first shaft 158 of the rod connector 100 and includes internal threading (not shown) that mates with the threading 159 of the first shaft 158. The threading may extend an entire length of the hole 1012. The first planar surface 1014 is positioned outboard of the second planar surface 1015 and is sized and positioned to engage the first planar face 152 of the rod connector 100 when the first shaft 158 is threaded entirely through the hole 1012, as described further below.

The second attachment plate 1030 may be the same as the first attachment plate 1010, including a first planar surface 1034, a second planar surface 1035, and a hole 1032 including threading that mates with the threading 161 of the second shaft 160. The first planar surface 1034 of the second attachment plate 1030 is positioned outboard of the second planar surface 1035 and is sized and positioned to engage the second planar face 154 of the rod connector 100 when the second shaft 160 is threaded entirely through the hole 1032, as described further below. The second attachment plate 1030 has a diameter that is about the same or slightly less than an inner diameter of the second rod 1004 so that an entire periphery of the second attachment plate 1030 is substantially flush with or engaging an interior side surface 1036 of the second rod 1004.

In some approaches, the cylindrical body 150 has a diameter that is about 30% to about 95%, about 50% to about 95%, or between about 65% to about 90% of the diameter of the first attachment plate 1010 and the second attachment plate 1030.

In various embodiments, instead of the illustrated attachment plates or nuts, there may be other fixed components or inserts that include, at least, the holes 1012, 1032 for receiving the first and second shafts 158, 160 and the first planar surfaces 1014, 1034 for engaging the planar faces 152, 154 of the cylindrical body 150.

Advantageously, the length of the cylindrical body 150 of the rod connector 100 and the distances the attachment plates 1010, 1030 are spaced from respective ends 1008, 1028 of the rods 1002, 1004 may be coordinated so that when the rod connector 100 is installed in the rods 1002, 1004, the cylindrical body 150 is sandwiched by the attachment plates 1010, 1030 and respective end surfaces 1008a, 1028a of the rods 1002, 1004 are in engagement or almost engaging. Thus, in the installed state, there is a smooth transition between the end surfaces 1008a, 1028a of the two rods 1002, 1004 while the sandwiched cylindrical body 150 provides rigidity and strength to the connection and ensures alignment of the rods 1002, 1004.

More specifically, the first attachment plate 1010 may be spaced or in-set from the end 1008 of the first rod 1002 by a first distance d₁. In this configuration, the distance between the first planar surface 1014 of the first attachment plate 1010 and the end 1008 of the first rod 1002 also may be d₁. Likewise, the second attachment plate 1030 may be spaced or in-set from the end 1028 of the second rod 1004 by a second distance d₂, such that the distance between the first planar surface 1034 of the second attachment plate 1030 and the end 10028 of the second rod 1042 also may be d₂. In some approaches, the first distance d₁ is equal or about equal to the second distance d₂.

The cylindrical body 150 of the rod connector 100 has a length l₁ (FIG. 1) from the first planar face 152 to the second planar face 154. In some embodiments, d₁ is equal to about half the length l₁ of the cylindrical body 150 and d₂ is equal to about half the length l₁ of the cylindrical body 150. Thus, in some embodiments, d₃, a distance between the first attachment plate 1010 and the second attachment plate 1030 when the first end surface 1008a of the first rod 1002 and the second end surface 1028a of the second rod 1004 are drawn into contact or near contact in the installed position, is equal or about equal to a sum of d₁ and d₂ and equal or about equal to the length l₁ of the cylindrical body 150 (e.g., no more than 1 mm more than the sum of d₁ and d₂ or the length l₁ of the cylindrical body 150.)

With these dimensions, when the rod connector 100 is fully installed, the cylindrical body 150 extends the entire distance d₃ between the first attachment plate 1010 and the second attachment plate 1030, with one half of the cylindrical body 150 received within the first rod 1002 and extending the distance d₁ and the other half of the cylindrical body 150 received within the second rod 1004 and extending the distance d₂. In this position, the first planar face 152 of the cylindrical body 150 engages or abuts the first planar surface 1014 of the first attachment plate 1010 and the second planar face 154 of the cylindrical body 150 engages or abuts the first planar surface 1034 of the second attachment plate 1030, while the first end surface 1008a of the first rod 1002 contacts or nearly contacts the second end surface 1028a of the second rod 1004, forming the smooth transition.

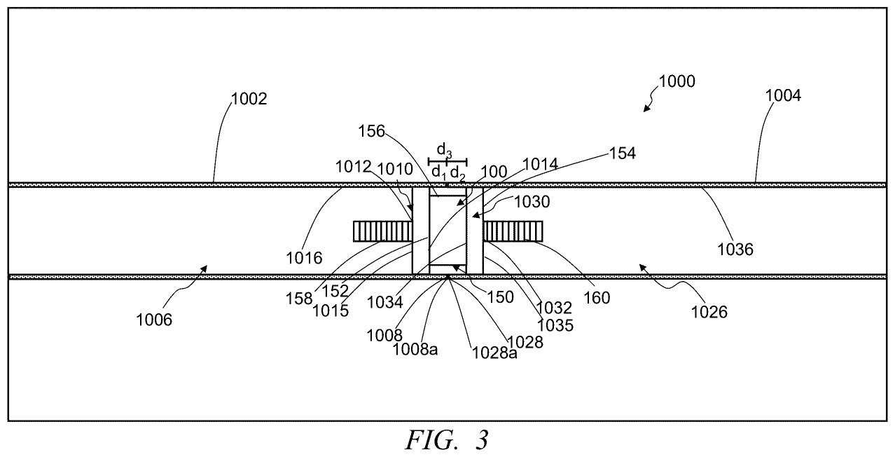

FIG. 3 illustrates the rod assembly 1000 with the rod connector 100 connecting the first rod 1002 to the second rod 1004. To install the rod connector 100, the first shaft 158 of the rod connector 100 is threaded into the hole 1012 of the first attachment plate 1010 all the way until the first planar face 152 of the cylindrical body 150 engages or abuts the first planar surface 1014 of the first attachment plate 1010. Half the length l₁ of the cylindrical body 150 is received within the first rod 1002 while the other half of the cylindrical body 150 protrudes from the first rod 1002. The second rod 1004 with the second attachment plate 1030 is then threaded onto the second shaft 160 of the rod connector 100 all the way until the first planar surface 1034 of the second attachment plate 1030 engages or abuts the second planar face 154 of the cylindrical body 150 and the second end surface 1028a of the second rod 1004 contacts or nearly contacts the first end surface 1008a of the first rod 1002. The first end surface 1008a and the second end surface 1028a may be flat faces that squarely engage in the installed state in some embodiments.

As illustrated, the cylindrical body 150 being directly sandwiched between the first attachment plate 1010 and the second attachment plate 1030 with substantial surface engagement between the attachment plates 1010, 1030 and the rod connector 100 maintains the first rod 1002 and the second rod 1005 in rigid, linear alignment as they are connected so that the first end surface 1008a of the first rod 1002 squarely contacts or nearly contacts the second end surface 1028a of the second rod 1004 and the rods 1002, 1004 do not bow out or become misaligned even when the rod assembly 1000 is supporting a heavy load. This also provides a smooth or substantially smooth transitional surface between the first rod 1002 and the second rod 1004 which permits or facilitates curtains and/or curtain rings or hooks which support a curtain to pass from the first rod 1002 to the second rod 1004, and vice versa, without catching on the transition as the curtains/curtain rings are drawn to one side or the other of the length of the rods 1002, 1004. For instance, in one example, when a user grasps and drags a curtain from the first rod 1002 to the second rod 1004 and past the transition, the holes, rings, or hooks of the curtain easily make the transition without slowing down, getting caught, or requiring additional force or maneuvering. Thus, as used herein, a “substantially smooth transition” means that the ends of the rods 1002, 1004 are sufficiently aligned and close together so when a user draws a curtain over the transition the holes, rings, or hooks of the curtain make the transition without slowing down, getting caught, or requiring additional force or maneuvering (such as lifting the holes, rings, or hooks over the transition).

It will be appreciated that in some approaches, the first end surface 1008a and the second end surface 1028a of the rods 1002, 1004 may engage or contact one another in the installed position or may be slightly spaced from one another in the installed position (e.g., less than 1 mm apart) and still achieve a smooth transition and appearance. Similarly, in some approaches, the cylindrical body 150 may be very close to the first attachment plate 1010 and the second attachment plate 1030 (e.g., within 1 mm) without actually contacting or engaging the plates 1010, 1030.

In some embodiments, such as the embodiment shown in FIG. 3, a rod connector 100 may have a cylindrical body 150 with a diameter sized so that the radial side surface 156 of the cylindrical body 150 is noticeably spaced from the inner side surfaces 1016, 1036 of the rods 1002, 1004. In this embodiment, the diameter of the cylindrical body 150 is large enough so that there is substantial engagement between the respective surfaces of the attachment plates 1010, 1030 and the cylindrical body 150 to create sufficient rigidity. For instance, the diameter of the cylindrical body 150 (e.g., at the first and second planar faces 152, 154) may be at least 50%, at least 60%, at least 70%, at least 80%, at least 90%, or at least 95% of the diameters of the planar surfaces 1014, 1034 of the first and second attachment plates 1010, 1030.

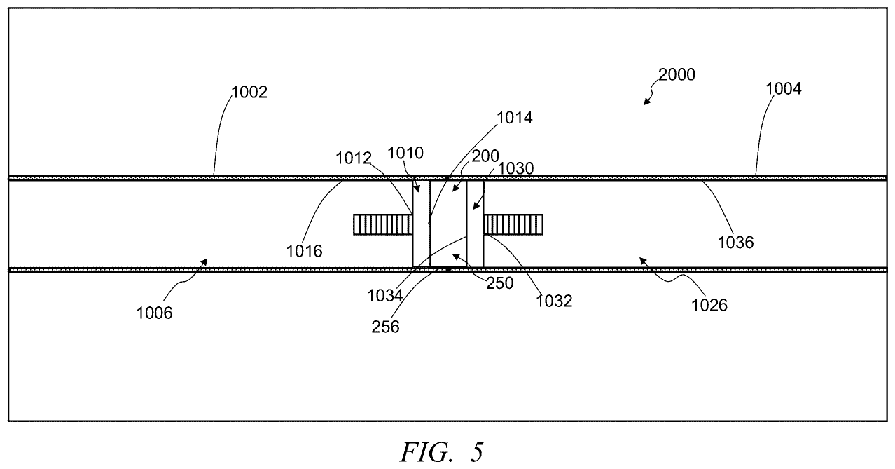

In some embodiments, such as in the rod assembly 2000 shown in FIG. 5, a rod connector 200 may have a cylindrical body 250 with a diameter only slightly less than the inner diameter of the first rod 1002 and the second rod 1004 so that the radial side surface 256 of the cylindrical body 250 engages or is only slightly spaced from the inner side surfaces 1016, 1036 of the rods 1002, 1004. For instance, in some approaches, the diameter of the cylindrical body 250 is about equal to the diameters of the first and second attachment plates 1010, 1030. In this configuration, maximal surface engagement between the attachment plates 1010, 1030 and the cylindrical body 150 and engagement of the cylindrical body with the inner side surfaces 1016, 1036 of the rods 1002, 1004 increases the rigidity and strength of the connection between the rods 1002, 1004.

By use of the rod connectors described herein, a curtain rod system may include two shorter rods that are easily joined together by the rod connector to form a longer rod upon assembly by the installer or end user. The curtain rod system with shorter rods may be contained, transported, stored, and displayed in a smaller box which reduces the costs of the box, the cost to transport the system, the cost to store the system, and the cost to display the system, all without compromising the functionality and utility of the curtain rod system. In addition, since the rod connectors are entirely within the rods and obscured from view, the rod assembly has a desirably minimal appearance and may appear as a single rod.

The rod connectors described herein may vary for use with rods of varying diameters. For instance, in various embodiments, the rod connectors may be sized to be used in rods having outer diameters spanning from 10 mm to 50 mm. In some approaches, a wall thickness of the rods and of the end surfaces 1008 a, 1028 a of the rods may be from about 0.10 mm to about 2.5 mm. The rod connectors are used to connect rods having the same diameter so that there is a smooth transition between the rods, though the rods may be different lengths.

In one non-limiting example, the rods 1002, 1005 may have an inner diameter of 0.96 in and an outer diameter of 1.0 in, the cylindrical body 150 may have a diameter of 0.71 in and a length of 0.37 in, each shaft 158, 160 may have a diameter of 0.2 in and a length of 0.6 in, and each attachment plate 1010, 1030 may have a length of 0.17 and a diameter of about 0.96 in.

The rod connectors, attachment plates, and rods described herein, or any variation thereof, may be formed of a metal material (e.g., steel, zinc, or aluminum) or made of carbon fiber. In some approaches, one or more of these components are formed of a plastic material, such as acrylonitrile butadiene styrene (ABS) or nylon. The rod connectors may be configured as a single, integral piece, which provides easy installation, and may be a molded or cast component.

The matter set forth in the foregoing description and accompanying drawings is offered by way of example and illustration only and not as a limitation. While certain embodiments have been shown and described, it will be apparent to those skilled in the art that additions, changes, and modifications may be made without departing from the broader aspects of the technological contribution. The actual scope of the protection sought is intended to be defined in the following claims.

What is claimed is:

1. A rod connector system comprising:
a rod connector comprising an insertable body having a first face at a first end and a second face at a second end, a first threaded shaft extending axially from the first face, and a second threaded shaft extending axially from the second face;
a first rod comprising a first attachment body within an interior thereof, the first attachment body including a first threaded hole for engaging the first threaded shaft and being spaced a first distance from an end of the first rod;
a second rod comprising a second attachment body within an interior thereof, the second attachment body including a second threaded hole for engaging the second threaded shaft and being spaced a second distance from an end of the second rod;
wherein when the first threaded shaft is threaded in the first threaded hole until the first attachment body and the first face engage, and the second threaded shaft is threaded in the second threaded hole until the second attachment body and the second face engage, the ends of the first and second rods translate towards one another, defining a connected state and a substantially smooth transition between the first rod and the second rod.

2. The system of claim 1, wherein the first distance is about equal to the second distance.

3. The system of claim 1, wherein the first distance and the second distance combine to be about equal to a length of the insertable body.

4. The system of claim 1, wherein one dimension of the first attachment body is about equal to an inner diameter of the first rod.

5. The system of claim 1, wherein in the connected state a first half of the insertable body is received in the first rod and a second half of the insertable body is received in the second rod.

6. The system of claim 1, wherein the insertable body is cylindrical.

7. The system of claim 6, wherein a radial cylindrical side surface of the insertable body is smooth.

8. The system of claim 1, wherein a first diameter of the first threaded shaft is at most about 60% of a second diameter of the insertable body.

9. The system of claim 7, wherein the radial cylindrical side surface is spaced from inner side surfaces of the first rod and the second rod in the connected state.

10. A rod connector system comprising:
a rod connector comprising a cylindrical body having a first planar face at a first end and a second planar face at a second end, a first threaded shaft extending axially from the first planar face, and a second threaded shaft extending axially from the second planar face;
a first hollow rod comprising a first inner wall within an interior thereof, the first inner wall including a first threaded hole for engaging the first threaded shaft and being spaced a first distance from an end of the first hollow rod;
a second hollow rod comprising a second inner wall within an interior thereof, the second inner wall including a second threaded hole for engaging the second threaded shaft and being spaced a second distance from an end of the second hollow rod;
wherein the first distance and the second distance are selected so that when the first threaded shaft is threaded into the first threaded hole and the second threaded shaft is threaded into the second threaded hole, the cylindrical body is sandwiched between the first inner wall and the second inner wall.

11. The system of claim 10, wherein the first distance and the second distance combine to be about equal to a length of the cylindrical body.

12. The system of claim 10, wherein when the cylindrical body is sandwiched between the first inner wall and the second inner wall, a substantially smooth transition is defined between the first rod and the second rod.

13. The system of claim 10, wherein the first distance is about equal to the second distance.

14. The system of claim 10, wherein the cylindrical body has a uniform diameter.

15. The system of claim 10, wherein a ratio of a first length of the cylindrical body to a second length of the first threaded shaft is at least 1:6.

16. The system of claim 10, wherein a first diameter of the first threaded shaft is at most about 60% of a second diameter of the cylindrical body.

17. A rod connector for connecting a first rod and a second rod, the rod connector comprising:
a cylindrical body having a first end, a second end, and a first diameter, the cylindrical body defined by a first planar face at the first end, a second planar face at the second end, and a radial cylindrical side surface,
a first shaft portion extending axially from the first planar face, the first shaft portion including first threading along at least a portion of a first length of the first shaft portion for engaging second threading within the first rod; and
a second shaft portion extending axially from the second planar face, the second shaft portion including third threading along at least a portion of a second length of the second shaft portion for engaging fourth threading within the second rod,
wherein a second diameter the first shaft portion is at most about 60% of the first diameter of the cylindrical body.

18. The rod connector of claim 17, wherein a ratio of a third length of the cylindrical body to the first length of the first shaft portion is at least 1:6.

19. The rod connector of claim 17, wherein the radial cylindrical side surface is smooth.

20. The rod connector of claim 17, wherein the first threading extends to the first planar face and the third threading extends to the second planar face.
